(19) United States
(12) Patent Application Publication
(10) Pub. No.: US 2008/0148574 A1
(43) Pub. Date: Jun. 26, 2008

(54) Vibration razor

(76) Inventor: Meng-Hsien Chou, Taipei (TW)

Correspondence Address: BIRCH STEWART KOLASCH & BIRCH, PO BOX 747, FALLS CHURCH, VA, 22040-0747, US

(21) Appl. No.: 11/808,864

(22) Filed: Jun. 13, 2007

(30) Foreign Application Priority Data
Dec. 20, 2006 (TW) 095147809

(51) Int. Cl. B26B 19/28

(52) U.S. Cl. 30/45

(57) ABSTRACT

The invention discloses a vibration razor, including a hand grip, a scraper head, and a vibration motor. The scraper head is connected to the hand grip and includes a plurality of blades forming a blade surface. The vibration motor is disposed in the hand grip or the scraper head. When the vibration motor is activated, the scraper head vibrates. It is conducive to shave a beard with the effect of rubbing. Therein, the vibration motor can be a coin-shaped vibration motor or a bar-shaped vibration motor. The bar-shaped vibration motor is disposed parallel to the scraper surface and perpendicular to the head grip. Thereby, the vibration razor of the invention is more efficiently conducive in shaving a beard.

### BACKGROUND OF THE INVENTION

1. Field of the Invention

The invention relates to a vibration razor and, more particularly, to a vibration razor with a coin-shaped vibration motor.

2. Description of the Prior Art

Cleanliness, comfort and safety for shaving are always important requirements of a razor, but these requirements usually impede one another. For example, to achieve cleanliness, the skin is often damaged by rough scraping; for comfort, additional lubricating process is needed to decrease the friction between the blade and the skin, but that often results in uncleanness; for safety's sake, the razor can not stay close to the skin so that uncleanness is easily procured.

To achieve these requirements, the design of the razor blade (comprising scraping mechanism) is important, and the force applied when using the razor also plays an important role at the same time. Because a suitable force enables a suitable contact between the blade of the razor and the skin, a force that is too light procures uncleanness and a force that is too heavy procures the damage of the skin. For typical razors, the force of beard shaving is completely controlled by the user. However, a suitable control of force is not always easy to attain, so that the results of uncleanness and the damage of the skin are often procured.

Presently, electric razors in the market use rotary scraper heads, and although through which the controlling demand of the force applied is decreased, the uncleanness still exists and the fact that no additional liquid or colloid for lubrication can be applied when using a rotary scraper head easily procures discomfort. Furthermore, the higher cost and heavier weight of the electric razors are detrimental for prevalence. Besides, some manufacturers simply dispose a vibration motor on a general razor, and attempt to assist beard shaving by the vibration generated by the vibration motor. However, without considering the vibration directions, the design not only fails to help with beard shaving but it easily damages the skin. At the same time, the use of an oversized vibration motor makes it inconvenient for the user.

Therefore, a new design of a razor is necessary to solve the above-mentioned problems.

### SUMMARY OF THE INVENTION

A scope of the invention is to provide a vibration razor.

Another scope of the invention is to provide a vibration razor using a micro vibration motor.

According to a preferred embodiment, the vibration razor of the invention comprises a hand grip, a scraper head, and a coin-shaped vibration motor. The scraper head is connected to the hand grip. The scraper head comprises at least one blade forming a blade surface. The coin-shaped vibration motor is disposed in the hand grip. Wherein, the coin-shaped vibration motor thereon defines a rotary axis.

When the rotary axis is substantially perpendicular to the blade surface, the coin-shaped vibration motor can generate vibration substantially parallel to the blade surface. Accordingly, the vibration razor itself can vibrate on the skin surface to help with beard chopping without creating damage to the skin while generating slight rubbing effect. When the rotary axis is substantially parallel to the blade surface, the coin-shaped vibration motor can generate a vibration substantially perpendicular to the blade surface, and because the vibration substantially presents a circle, it is efficiently conducive in shaving a beard. Furthermore, when the rotary axis is perpendicular to the moving direction of the scraper head during the shaving, it is more efficiently conducive in shaving a beard. When an included angle exist between the rotary axis and the blade surface, the vibration razor can generate vibration parallel and perpendicular to the blade surface at the same time and combine the two above-mentioned effects.

According to another preferred embodiment, the vibration razor of the invention comprises a hand grip, a scraper head, and a vibration motor. The scraper head is connected to the hand grip. The hand grip thereon defines an axis. The scraper head comprises at least one blade forming as a blade surface. The vibration motor is disposed in the hand grip. The vibration motor comprises a rotary shaft. The rotary shaft is substantially parallel to the blade surface and substantially perpendicular to the axis.

Besides, the hand grip has a front end and the scraper head is connected to the front end. The vibration motor is disposed in the front end to increase the vibration range of the scraper head. The rotary shaft of the vibration motor is connected to an eccentric head for generating vibration during the rotation of the rotary shaft.

Because the rotary shaft of the vibration motor is substantially parallel to the blade surface and substantially perpendicular to the axis, the vibration razor can generate a circular vibration substantially perpendicular to the blade surface and substantially parallel to the axis. And because the axis is substantially parallel to the moving direction of the scraper head during the chopping of a beard, the vibration generated by the vibration motor is efficiently conducive in shaving a beard.

Therefore, according to the above-mentioned embodiments, the vibration razor of the invention can generate the needed vibrating effect by disposing the vibration motor in different places with different moving directions to satisfy different requirements. Accordingly, the problems generated in the prior art can be prevented or alleviated and preferred effects are created. Besides, the vibration razor of the invention can use a micro vibration motor to increase the possibility of choosing the vibration directions, to increase the vibration capability, and to enhance the appearance of the product.

The advantage and spirit of the invention may be understood by the following recitations together with the appended drawings.

### BRIEF DESCRIPTION OF THE APPENDED DRAWINGS

FIG. 1A is a schematic diagram illustrating a vibration razor according to a first preferred embodiment.

FIG. 1B is a bottom view of the vibration razor shown in FIG. 1A.

FIG. 2A is a schematic diagram illustrating the vibration razor according an embodiment.

FIG. 2B is a bottom view of the vibration razor shown in FIG. 2A.

FIG. 2C is a schematic diagram illustrating vibration generated by the vibration razor according to the embodiment.

FIG. 2D is a schematic diagram illustrating the vibration razor according another embodiment.

FIG. 3A is a schematic diagram illustrating a vibration razor according to a second preferred embodiment.

FIG. 3B is a bottom view of the vibration razor shown in FIG. 3A.

### DETAILED DESCRIPTION OF THE INVENTION

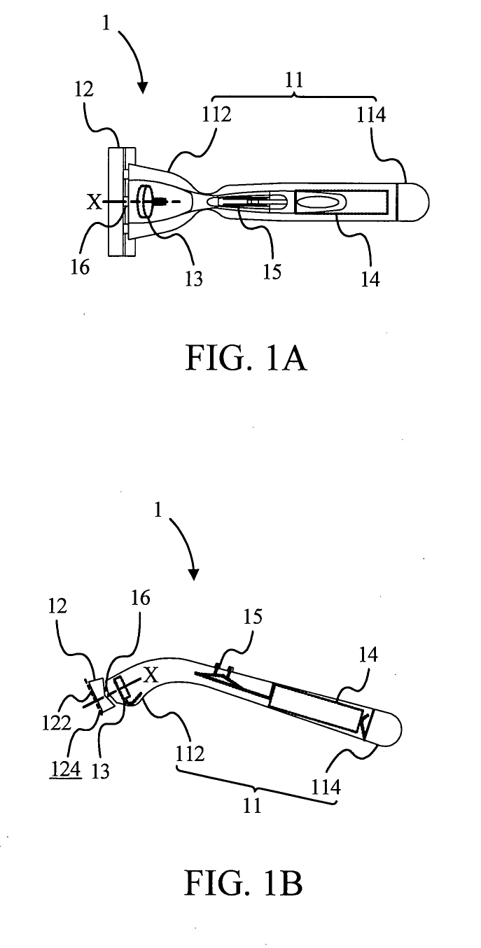

Please refer to FIG. 1A and FIG. 1B. FIG. 1A is a schematic diagram illustrating a vibration razor 1 according to a first preferred embodiment. FIG. 1B is a bottom view of the vibration razor 1 shown in FIG. 1A. The vibration razor 1 of the invention comprises a hand grip 11, a scraper head 12, a coin-shaped vibration motor 13, a battery 14, and a switch 15. The hand grip 11 slightly presents a V shape but is not limited in practical application. The hand grip 11 comprises a front end 112 and a back cover 114. The scraper head 12 comprises several blades 122, and the blades 122 form a blade surface 124. The coin-shaped vibration motor 13 thereon defines a rotary axis X. The coin-shaped vibration motor 13 is disposed in the front end 112 and the rotary axis X is substantially perpendicular to the blade surface 124. The battery 14 is disposed in the hand grip 11 and is electrically connected to the coin-shaped vibration motor 13. The switch 15 is disposed on the hand grip for switching on/off the coin-shaped vibration motor.

According to the first preferred embodiment, the operation of the coin-shaped vibration motor 13 enables the vibration razor 1 of the invention to generate vibration substantially parallel to the blade surface 124 and substantially presents the vibration in a circle. Accordingly, the scraper head 12 of the vibration razor 1 can shave a beard along the skin surface. Combining with the general beard shaving movement of the user, the vibration razor 1 is more efficiently conducive in shaving a beard and is capable of providing a slight massaging effect.

Additionally, the battery 14 can be inserted in the hand grip 11 from under the back cover 114 of the hand grip 11, and then the back cover 114 is closed. The switch 15 can control whether the power of the battery 14 is outputted to the coin-shaped vibration motor 13 when switching on the coin-shaped vibration motor 13. According to the first preferred embodiment, the switch 15 controls whether the circuit is on or off by two metal domes, but in the practical design of the product, the position and shape of the switch 15 are not limited to those in this embodiment. For example, the switch 15 can be a tact switch disposed on the scraper head 12, so that when the blade surface 124 approaches or contacts an object, the switch 15 switches on the coin-shaped vibration motor 13.

Besides, in the practical design of the product, the back cover 114 can also be designed as a charging joint for charging the battery 14. In such cases, the battery 14 should certainly be a rechargeable battery. Besides, the vibration razor 1 of the invention further comprises a connection mechanism 16 for connecting the scraper head 12, so that the scraper head 12 can be detachably connected to the front end 112 of the hand grip 11. Whereby, when the blades 122 of the scraper head 12 are worn out, the scraper head can be replaced to increase the practical benefit of the vibration razor 1 of the invention.

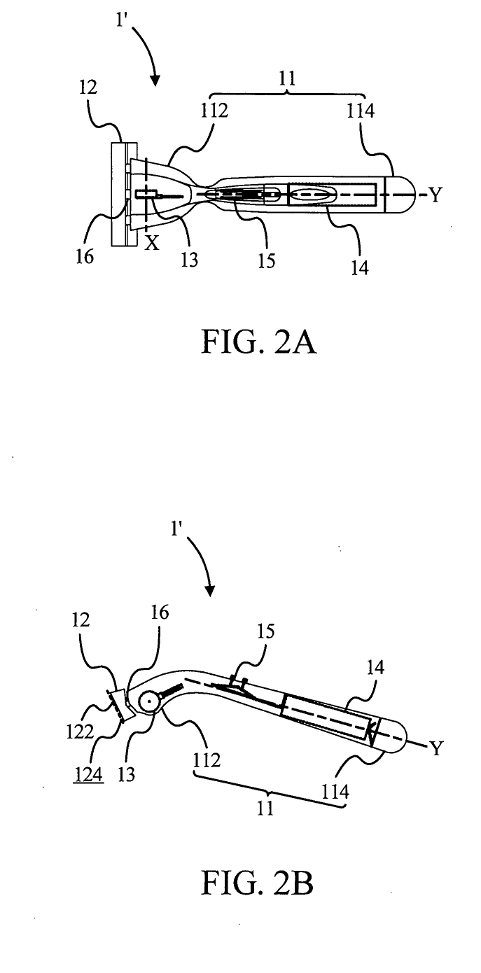

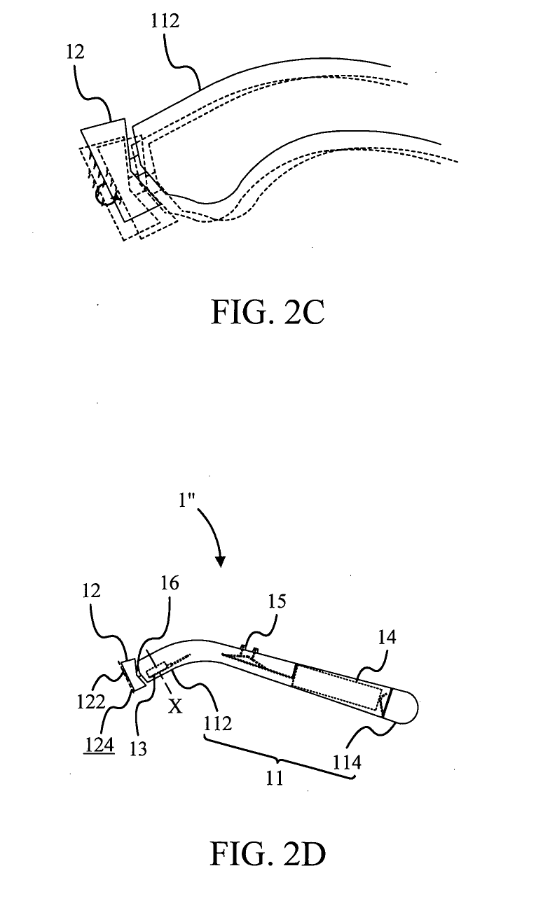

Please refer to FIG. 2A and FIG. 2B. FIG. 2A is a schematic diagram illustrating a vibration razor 1′ according to an embodiment. FIG. 2B is a bottom view of the vibration razor 1′ shown in FIG. 1A. Compared to the first preferred embodiment, the hand grip 11 of the vibration razor 1′ thereon defines an axis Y, the rotary axis X of the coin-shaped vibration razor 13 is substantially parallel to the blade surface 124 and substantially perpendicular to the axis Y, as shown in FIG. 2A and FIG. 2B. The other portions of the vibration razor 1′ are the same with those of the vibration razor 1 in the first preferred embodiment, and the related descriptions are not to be described here.

According to the embodiment, the operation of the coin-shaped vibration motor 13 enables the vibration razor 1′ of the invention to generate vibration substantially perpendicular to the blade surface 124, substantially parallel to the axis Y, and substantially presenting a circle. Therefore, the vibration generated by the vibration razor 1′ has the effect of mincing a beard, as shown in FIG. 2C. Furthermore, because the general beard shaving movement is substantially along the axis Y, the vibration razor 1′ is more efficiently conducive in shaving a beard by cooperating to the general beard shaving movement of the user.

It should be noted that if an included angle exists between the rotary axis X and the blade surface 124, the vibration generated by the vibration razor of the invention can be decomposed to a vibration component parallel to the blade surface 124 and another vibration component perpendicular to the blade surface 124, i.e., the two foregoing embodiments are combined for analysis. In other words, the vibration razor has the benefits shown in the two foregoing embodiments at the same time.

It is worth mentioning that the coin-shaped vibration motor 13 of the foregoing embodiments is disposed in the hand grip 11, but in the practical applications, because the diameter of the coin-shaped vibration 13 can be less than 8 mm and the thickness of the coin-shaped vibration 13 can be less than 2.5 mm, the coin-shaped vibration 13 can also be disposed in the scraper head 12 but would not overly increase the volume of the scraper head 12. Besides, please refer to FIG. 2D. FIG. 2D is a schematic diagram illustrating a vibration razor 1″ according to another embodiment. Compared to the first preferred embodiment, the coin-shaped vibration motor 13 of the vibration razor 1″ is disposed on the front end 112 of the hand grip 11. Through the designing of a suitable appearance, the vibration razor 1″ can be practically similar to the general razor in appearance. Furthermore, because the volume of the coin-shaped vibration motor 13 is very small, the coin-shaped vibration motor 13 can be disposed in the hand grip with any angle for achieving the same effect mentioned in the foregoing embodiments.

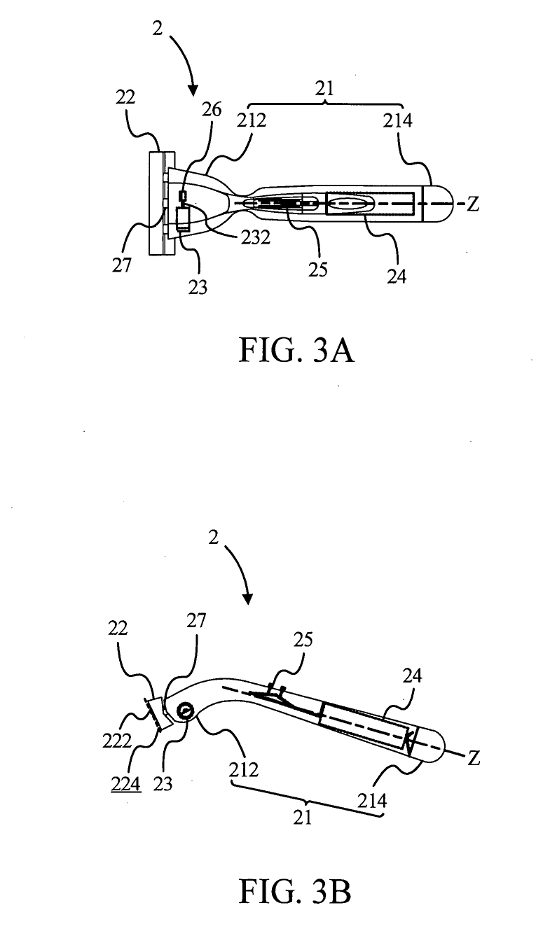

Please refer to FIG. 3A and FIG. 3B. FIG. 3A is a schematic diagram illustrating a vibration razor 2 according to a second preferred embodiment. FIG. 3B is a bottom view of the vibration razor 2 shown in FIG. 3A. The vibration razor 2 of the invention comprises a hand grip 21, a scraper head 22, a vibration motor 23, a battery 24, and a switch 25. The hand grip 21 slightly presents a V shape and thereon defines an axis Z. The hand grip 21 comprises a front end 212 and a back cover 214. The scraper head 22 comprises several blades 222, and the blades 222 form a blade surface 224. The vibration motor 23 comprises a rotary shaft 232, and the shaft 232 is connected to an eccentric head 26 for generating vibration during the operation of the vibration motor 23. The vibration motor 23 is disposed in the front end 212, and the rotary shaft 232 is substantially parallel to the blade surface 224 and substantially perpendicular to the axis Z. The battery 24 is disposed in the hand grip 21 and is electrically connected to the vibration motor 23. The switch 25 is disposed in the hand grip 21 for switching on the vibration motor 23.

According to the second preferred embodiment, the operation of the vibration motor 23 enable the vibration razor 2 of the invention to generate vibration substantially perpendicular to the blade surface 224, substantially parallel to the axis Y, and substantially presenting in a circle. Therefore, the vibration generated by the vibration razor 2 can mince a beard. The mechanism is equal to that of the above-mentioned vibration razor 1′, and the schematic diagram of the mechanism refers to FIG. 2C. For the same reason, because the general beard shaving movement is substantially done along the axis Z, the vibration razor 2 is more efficiently conducive in shaving a beard by cooperating with the general beard shaving movement of the user.

Additionally, the vibration razor 2 further comprises a connection mechanism 27 for connecting the scraper head 22, so that the scraper head 22 can be detachably connected to the front end 212 of the hand grip 21. Wherein, the other features and limitations of the battery 24, the switch 25, and the connection mechanism 27 are the same with those of the battery 14, the switch 15, and the connection mechanism 16 of the vibration razor 1 in the first preferred embodiment, and then the related descriptions are not described here. The descriptions related to the other similar portions in the first preferred embodiment are also suitable in the second preferred embodiment, such as the hand grip 21 is not limited to a V shape.

It's worth mentioning that, in the second preferred embodiment, because the diameter of the vibration motor 23 can be less than 6 mm and the total length (included the eccentric head 26) of the vibration motor 23 can be less than 20 mm, the vibration motor 23 can be easily disposed in the front end 212 of the hand grip 21 but would not overly increases the volume of the front end 212 of the hand grip 21.

From what was mentioned above, the vibration razor of the invention satisfies different requests by disposing the vibration motor in different places to acquire needed vibration. Accordingly, the problems generated by the prior art are either prevented or alleviated, and preferred effects are acquired. Besides, the vibration razor of the invention can use a micro vibration motor to increase the possibility of the choice of the vibration directions, to increase the vibration capability, and to enhance the appearance of product.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A vibration razor, comprising:
a hand grip;
a scraper head, connected to the hand grip, comprising at least one blade, the at least blade forming a blade surface; and
a coin-shaped vibration motor disposed in the hand grip or the scraper head, the coin-shaped vibration motor thereon defining a rotary axis.

2. The vibration razor of claim 1, wherein the rotary axis is substantially perpendicular to the blade surface.

3. The vibration razor of claim 1, wherein the rotary axis is substantially parallel to the blade surface.

4. The vibration razor of claim 1, wherein an included angle exists between the rotary axis and the blade surface.

5. The vibration razor of claim 1, further comprising a switch disposed on the hand grip for switching on/off the coin-shaped vibration motor.

6. The vibration razor of claim 1, further comprising a battery electrically connected to the coin-shaped vibration motor and disposed in the hand grip.

7. A vibration razor, comprising:
a hand grip thereon defining an axis;
a scraper head, connected to the hand grip, comprising at least one blade, the at least one blade forming a blade surface; and
a vibration motor, disposed in the hand grip or the scraper head, comprising a rotary shaft, the rotary shaft being substantially parallel to the blade surface and substantially perpendicular to the axis.

8. The vibration razor of claim 7, wherein the rotary shaft of the vibration motor is connected to an eccentric head.

9. The vibration razor of claim 8, wherein the hand grip has a front end, the scraper head is connected to the front end, and the vibration motor is disposed in the front end.

10. The vibration razor of claim 7, further comprising a switch disposed on the hand grip for switching on/off the vibration motor.

11. The vibration razor of claim 7, further comprising a switch disposed on the scraper head, so that when the blade surface approaches or contacts an object, the switch switches on/off the vibration motor.

12. The vibration razor of claim 7, further comprising a battery electrically connected to the vibration motor and disposed in the hand grip.

13. The vibration razor of claim 7, further comprising a connection mechanism, wherein the scraper head is detachably connected to the hand grip by a connecting mechanism.
